(19) United States
(12) Patent Application Publication
(10) Pub. No.: US 2026/0296046 A1
(43) Pub. Date: Oct. 1, 2026

(54) LIQUID FILLING METHOD AND LIQUID DISCHARGE HEAD

(71) Applicant: CANON KABUSHIKI KAISHA, Tokyo (JP)

(72) Inventor: TAKUMA KODOI, Kanagawa (JP)

(21) Appl. No.: 19/572,601

(22) Filed: Mar. 19, 2026

(30) Foreign Application Priority Data
Mar. 25, 2025 (JP) 2025-049638

(51) Int. Cl. B41J 2/18; B41J 2/165; B41J 2/175

(52) U.S. Cl. CPC B41J 2/18; B41J 2/16505; B41J 2/17596

(57) ABSTRACT

A method for filling a liquid discharge head including a recording element substrate configured to discharge a liquid, a common supply liquid chamber configured to supply the liquid to the recording element substrate, a first introduction channel configured to introduce the liquid into the common supply liquid chamber, a first discharge channel configured to discharge the liquid from the common supply liquid chamber, a common collection liquid chamber configured to collect the liquid from the recording element substrate, a second introduction channel configured to introduce the liquid into the common collection liquid chamber, and a second discharge channel configured to discharge the liquid from the common collection liquid chamber, the method comprising introducing the liquid from the first introduction channel into the common supply liquid chamber in a state where the second discharge channel is closed and the first discharge channel is open.

### BACKGROUND

### Field of the Technology

The present disclosure relates to a method for filling a liquid discharge head.

### Description of the Related Art

A liquid discharge head for discharging a liquid, such as ink, may experience a discharge failure due to an increase in viscosity of the liquid remaining in pressure chambers communicating with discharge ports caused by evaporation of moisture in the liquid from the discharge port. Thus, a method for circulating the liquid through the pressure chambers is used to prevent the liquid with increased viscosity from remaining in the pressure chambers.

Japanese Patent Laid-Open No. 2022-16691 discusses a configuration in which an individual supply channel and an individual collection channel, communicating with a pressure chamber, communicate with a common supply channel and a common collection channel connecting a plurality of individual channels, and the two common channels are connected to a negative-pressure control unit. A liquid adjusted to two different negative pressures (high negative pressure and low negative pressure) by the negative-pressure control unit is divided into the common supply channel (high negative pressure) and the common collection channel (low negative pressure), and then circulated to the pressure chamber due to the differential pressure between the two common channels.

However, according to the configuration discussed in Japanese Patent Laid-Open No. 2022-16691, when ink is first introduced into a liquid discharge head, if dust and foreign substances are present in components, such as the negative-pressure control unit, such dust and foreign substances may be introduced into, for example, discharge ports of recording element substrates, which can adversely affect discharge stability.

### SUMMARY

The present disclosure is directed to a liquid filling method and a liquid discharge head that provide high reliability, including discharge stability.

An aspect of the present disclosure provides a method for filling a liquid discharge head including a recording element substrate configured to discharge a liquid, a common supply liquid chamber configured to supply the liquid to the recording element substrate, a first introduction channel configured to introduce the liquid into the common supply liquid chamber, a first discharge channel configured to discharge the liquid from the common supply liquid chamber, a common collection liquid chamber configured to collect the liquid from the recording element substrate, a second introduction channel configured to introduce the liquid into the common collection liquid chamber, and a second discharge channel configured to discharge the liquid from the common collection liquid chamber, the method including introducing the liquid from the first introduction channel into the common supply liquid chamber in a state where the second discharge channel is closed and the first discharge channel is open.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are diagrams each illustrating an overall configuration of a liquid discharge head. FIG. 1C is an exploded perspective view illustrating the liquid discharge head.

FIG. 2A is a diagram illustrating an overall configuration according to a first embodiment. FIGS. 2B and 2C are cross-sectional views each illustrating a liquid discharge head according to the first embodiment. FIG. 2D is a diagram illustrating a sequence of ink filling of the liquid discharge head according to the first embodiment.

FIGS. 3A to 3D are diagrams each illustrating a liquid discharge unit of the liquid discharge head according to the first embodiment.

FIG. 4A is a diagram illustrating an overall configuration of a liquid discharge head according to a second embodiment. FIG. 4B is a diagram illustrating a sequence of ink filling of the liquid discharge head.

FIGS. 5A and 5B are diagrams each illustrating an overall configuration of a liquid discharge head according to a third embodiment.

FIG. 6 is a diagram illustrating an overall configuration of a liquid discharge head according to a fourth embodiment.

### DESCRIPTION OF THE EMBODIMENTS

Embodiments of the present disclosure are described below with reference to the accompanying drawings, without limiting the scope of the present disclosure. For example, the present embodiments employ a thermal method for producing air bubbles by using heating elements to discharge a liquid. The present disclosure is also applicable to a liquid discharge head employing a piezoelectric method and other various liquid discharge methods.

The present embodiments disclose an inkjet recording apparatus (liquid discharge apparatus) with a configuration in which a liquid, such as ink, is circulated between ink tanks and a liquid discharge head. However, the present embodiments are not limited thereto and also applicable to other configurations. Examples of applicable configurations include a configuration without ink circulation with two tanks disposed upstream and downstream of the liquid discharge head, with the ink sent from one tank to the other to cause the ink to flow in a pressure chamber. According to the present embodiments, a liquid is sent from an inlet port disposed at one end of the liquid discharge head to an outlet port disposed at the opposite end of the liquid discharge head. Alternatively, a liquid may be sent from an inlet port disposed near the center of the liquid discharge head to outlet ports disposed at both ends of the liquid discharge head.

In the present embodiments, a line type (page wide type) liquid discharge head having a length corresponding to a width of a recording medium is employed. However, the present disclosure is also applicable to a serial type liquid discharge head that performs recording while moving relative to a recording medium. An example of a serial type liquid discharge head is a liquid discharge head with one recording element substrate for black ink and one recording element substrate for color ink. Examples of other applicable configurations include a liquid discharge head having a length shorter than a width of a recording medium and having a plurality of recording element substrates with discharge ports overlapping each other in the discharge port array direction, where the liquid discharge head is moved relative to the recording medium.

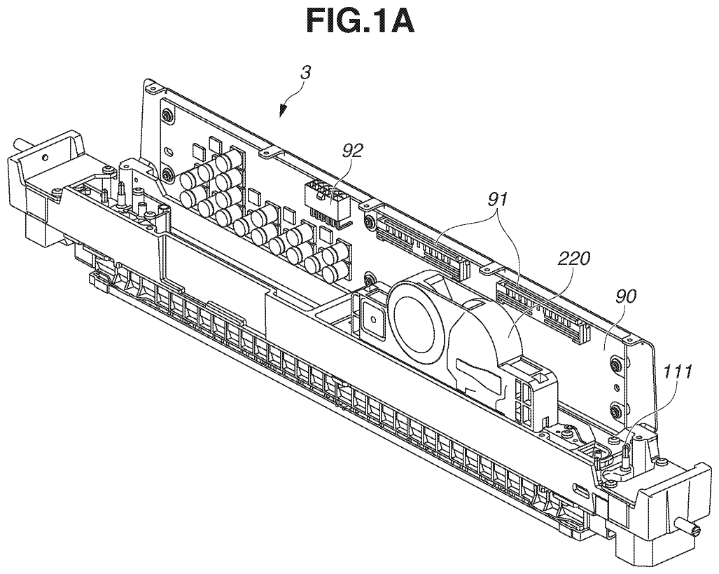

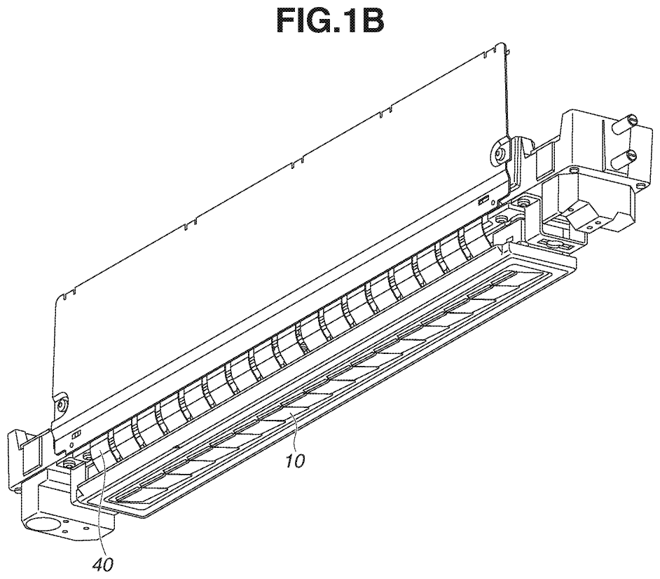

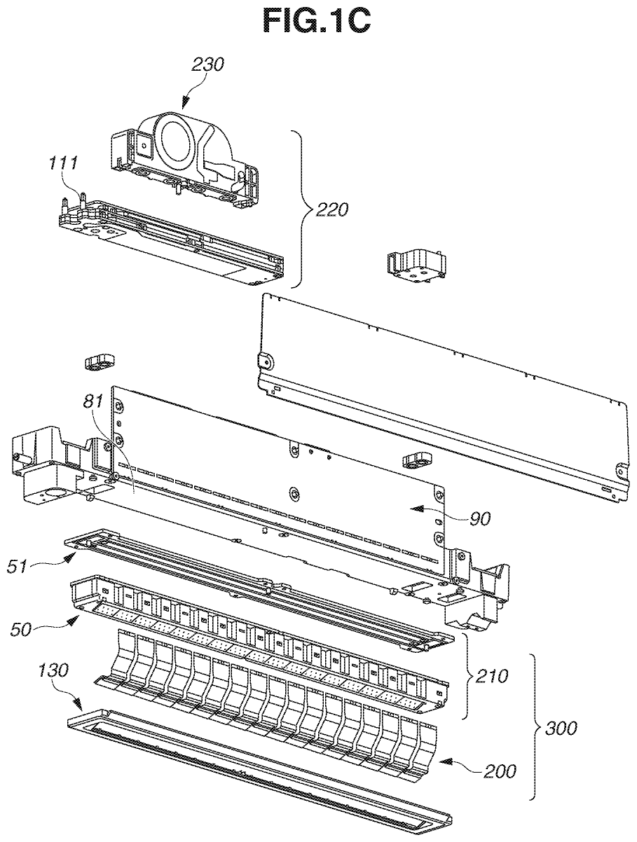

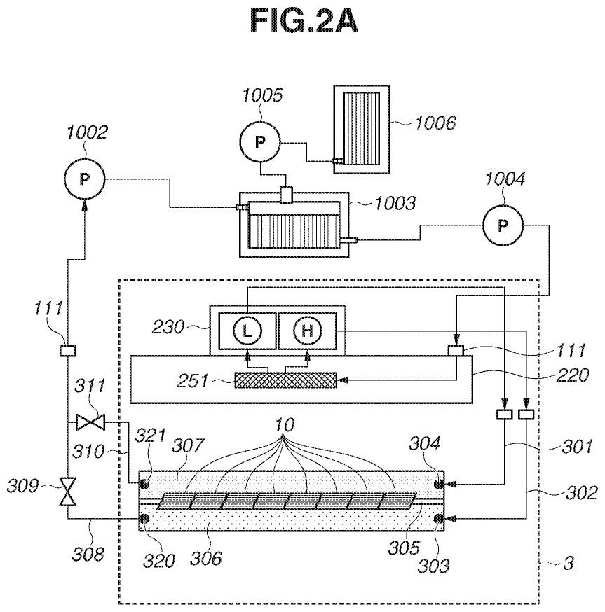

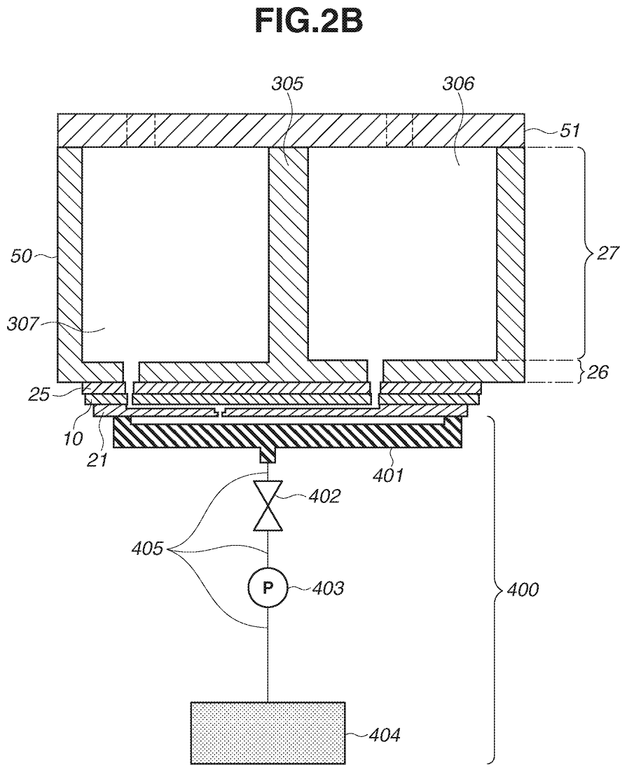

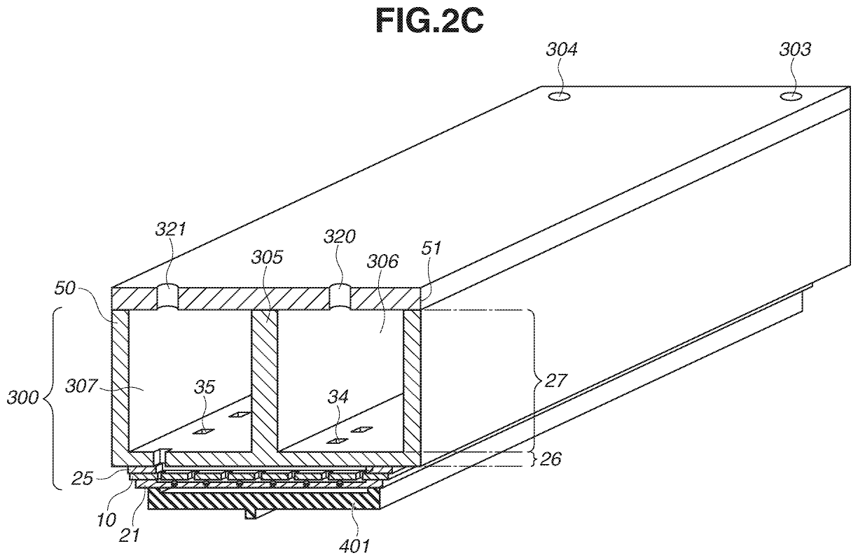

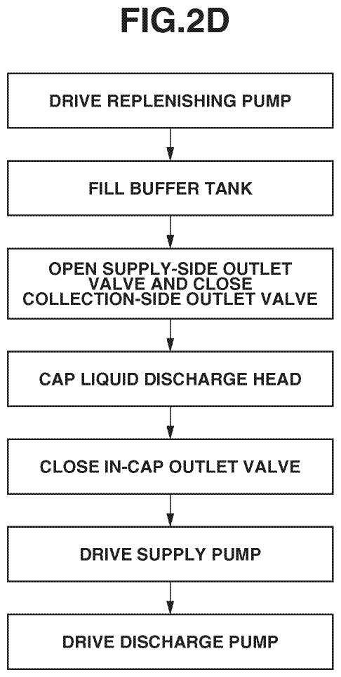

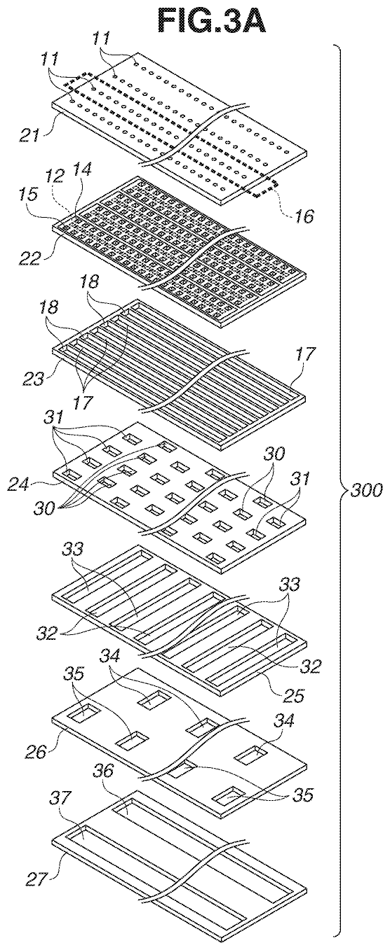

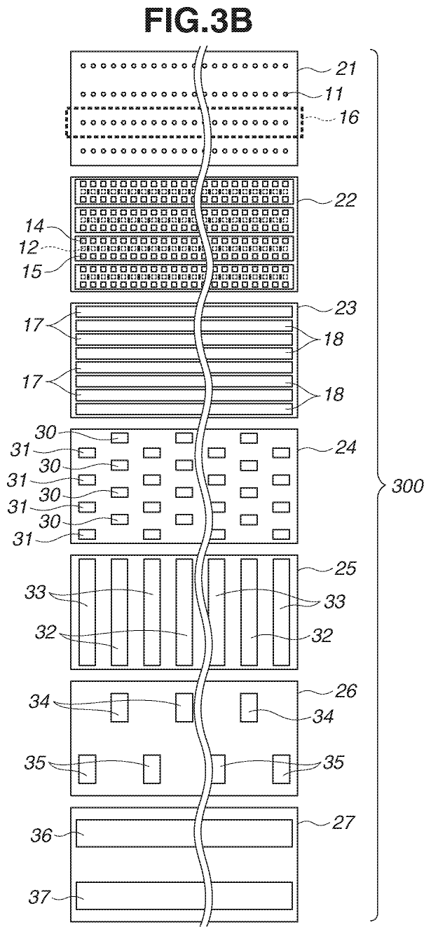

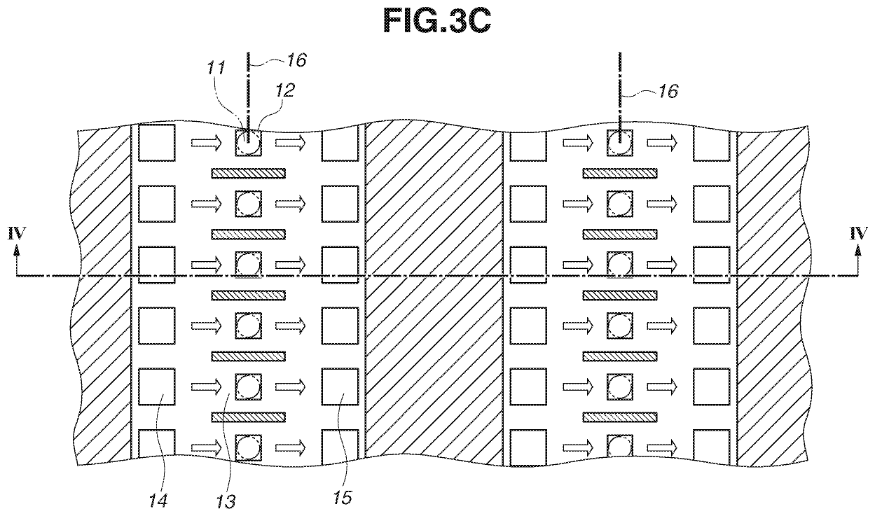

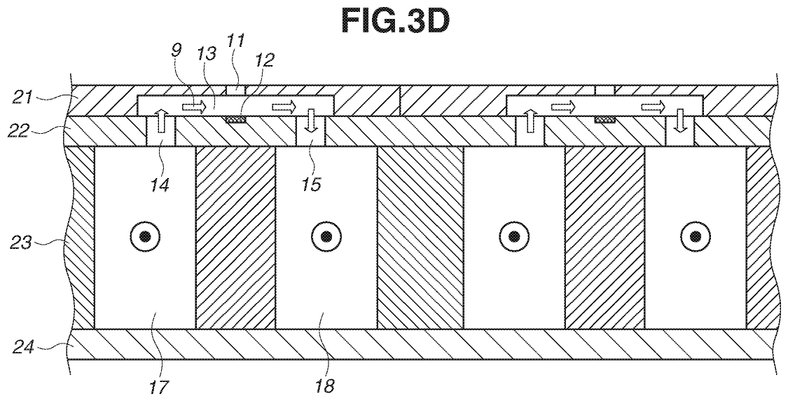

A configuration of the liquid discharge unit 300 is described with reference to FIGS. 3A to 3D, describing an ink circulating mechanism of a liquid discharge unit 300 illustrated in FIGS. 1A to 1C and 2A to 2C.

FIGS. 3A to 3D are diagrams each illustrating the liquid discharge unit 300 according to a first embodiment of the present disclosure. The liquid discharge unit 300 is included in a liquid discharge head and is attached to a liquid discharge apparatus described below.

As illustrated in FIGS. 3A and 3B, the liquid discharge unit 300 according to the present embodiment includes an orifice plate 21 and six channel layers stacked on top of each other: a first channel layer 22, a second channel layer 23, a third channel layer 24, a fourth channel layer 25, a fifth channel layer 26, and a sixth channel layer 27. The six channel layers are provided inside a component including a channel member 210 (FIG. 1C), configured by a first channel member 50 (FIGS. 1C, 2B, 2C) and a second channel member 51 (FIGS. 1C, 2B, 2C), and recording element substrates 10 (FIG. 2A). The first channel layer 22 is provided with discharge energy generation elements 12 for producing discharge energy for discharging liquid. The discharge energy causes the ink in pressure chambers 13 to be discharged from discharge ports 11 in the orifice plate 21. When the ink in the pressure chambers 13 is in a static state, the pressures inside the pressure chambers 13 are maintained at a negative pressure under which ink meniscuses are formed at the discharge ports 11. If the pressures inside the pressure chambers 13 vary, the discharge speeds or ink discharge amounts (volumes) change, affecting the ink discharge characteristics. If the pressures inside the pressure chambers 13 fall below a predetermined pressure, an ink discharge failure may occur.

An electrothermal conversion element (heater) or a piezoelectric element can be used as each of the discharge energy generation elements 12. When a heater is employed, the heat generated by the heater generates bubbles in the ink in the pressure chambers 13, and the energy of the bubbles can be utilized to discharge the ink from the discharge ports 11.

A plurality of the discharge ports 11 are densely arranged in a discharge port array 16, as illustrated in FIG. 3C. In the present embodiment, four discharge port arrays 16 are disposed. Although the present embodiment describes a case with four discharge port arrays 16, with the number of arrays not limited thereto. As illustrated in FIG. 3D, a first common supply channel 17 in the second channel layer 23 communicates with one end of each pressure chamber 13 via a supply channel 14 individually corresponding to the pressure chamber 13 and a channel 9. Likewise, a first common collection channel 18 in the second channel layer 23 communicates with the other end of each pressure chamber 13 via the channel 9 and a collection channel 15 from the pressure chamber 13, individually corresponding to the pressure chamber 13. A plurality of the supply channels 14 and a plurality of the collection channels 15 extend in a thickness direction of the first channel layer 22 and are arranged in an extending direction (first direction) of the discharge port arrays 16, thus serving as supply channel arrays and collection channel arrays, respectively. The thickness direction of the first channel layer 22 corresponds to a direction intersecting with (according to the present embodiment, perpendicularly intersecting with) a plane of a liquid discharge substrate on which the discharge energy generation elements 12 are disposed.

The first common supply channels 17 communicate with first supply ports 30 disposed in the third channel layer 24 and receive ink supplied from the first supply ports 30. Likewise, the first common collection channels 18 communicate with first collection ports 31 disposed in the third channel layer 24. A plurality of the first supply ports 30 arranged in the extending direction (first direction) of the discharge port arrays 16 serves as a first supply port array. Likewise, a plurality of the first collection ports 31 arranged in the direction along the first supply port array serves as a first collection port array. In the third channel layer 24, four first supply port arrays and four first collection port arrays are alternately disposed in parallel with each other. In the fourth channel layer 25, a plurality of second common supply channels 32 and a plurality of second common collection channels 33 are disposed. In the fifth channel layer 26, a plurality of second supply ports 34 and a plurality of second collection ports 35 are disposed. In the sixth channel layer 27, a third common supply channel 36 and a third common collection channel 37 are disposed.

One side of each of the first common supply channels 17 in the thickness direction of the second channel layer 23 (the side facing the first channel layer 22) communicates with corresponding channels among the plurality of the supply channels 14, and the other side (the side facing the third channel layer 24) communicates with corresponding ports among the plurality of the first supply ports 30. Likewise, one side of each of the first common collection channels 18 in the thickness direction of the second channel layer 23 communicates with corresponding channels among the plurality of the collection channels 15, and the other side communicates with corresponding ports among the plurality of the first collection ports 31. One side of each of the second common supply channels 32 in the thickness direction of the fourth channel layer 25 communicates with corresponding ports among the plurality of the first supply ports 30, and the other side communicates with a corresponding port among the second supply ports 34. Likewise, one side of each of the second common collection channels 33 in the thickness direction of the fourth channel layer 25 communicates with corresponding ports among the plurality of the first collection ports 31, and the other side communicates with a corresponding port among the second collection ports 35. The third common supply channel 36 communicates with the second supply ports 34. The third common collection channel 37 communicates with the second collection ports 35.

An array density of the plurality of second supply ports 34 and an array density of the plurality of second collection ports 35 are lower than an array density of the plurality of first supply ports 30 and an array density of the plurality of first collection ports 31. An array density of the plurality of first supply ports 30 and an array density of the plurality of first collection ports 31 are lower than an array density of the plurality of supply channels 14 and an array density of the plurality of collection channels 15. The first common supply channels 17 and the first common collection channels 18 extend parallel with the first direction. The second common supply channels 32 and the second common collection channels 33 extend in parallel in a second direction. The third common supply channel 36 and the third common collection channel 37 extend parallel with the first direction.

As described above, the liquid discharge unit 300 according to the present embodiment includes a plurality of channel layers stacked on top of each other.

The channel formation densities of these channel layers increase in order of the sixth channel layer 27, the fifth channel layer 26, the fourth channel layer 25, the third channel layer 24, the second channel layer 23, and the first channel layer 22. With this configuration, the liquid discharge unit 300 with the plurality of the discharge port arrays 16 arranged with a high density can be achieved without increasing sizes of an element substrate and the channel members. A part of the fifth channel layer 26 serves as a bottom surface of the first channel member 50 according to the present embodiment. The sixth channel layer 27 serves as side walls of the first channel member 50 and a liquid chamber partition wall 305.

The ink supplied from the outside is led from the third common supply channel 36 communicating with an ink inflow opening, passes through the second supply ports 34, the second common supply channels 32, the first supply ports 30, the first common supply channels 17, and the supply channels 14 in this order, and is led to the pressure chambers 13. The ink in the pressure chambers 13 passes through the collection channels 15, the first common collection channels 18, the first collection ports 31, the second common collection channels 33, the second collection ports 35, and the third common collection channel 37 in this order, and is collected from a collection opening communicating with the third common collection channel 37 and discharged to the outside. By circulating ink in this way, thickened ink which tends to remain in the pressure chambers 13 is collected, thus preventing a decrease in the ink discharge speed from the discharge ports 11 and a change in the density of colorant in the ink. Such forced flow of ink may be referred to as an ink circulation flow.

According to the present embodiment, each of the supply channels 14 and a corresponding channel among the collection channels 15 are disposed to face each other across a corresponding port among the discharge ports 11, as illustrated in FIGS. 3C and 3D. With the supply channels 14 and the collection channels 15 facing each other, an ink circulation flow passing through the pressure chambers 13 and the discharge ports 11 is efficiently generated, thus efficiently preventing a decrease in the ink discharge speed from the discharge ports 11 and a change in the density of colorant in the ink. The supply channels 14 and the collection channels 15 are arranged in a plurality of sections in the first direction in which the discharge port arrays 16 extend, so as to correspond to the respective pressure chambers 13. With the supply channels 14 and the collection channels 15 arranged in the plurality of sections, electrical wiring for driving the discharge energy generation elements 12 can be arranged between adjacent supply channels 14 and between adjacent collection channels 15. This eliminates the need for arranging wiring extending in the first direction between the supply channels 14 and the discharge ports 11 and between the collection channels 15 and the discharge ports 11, allowing further reduction in the gaps between these portions. The relation between the number of supply channels 14 and the number of discharge ports 11 may be one to one, one to two, one to five, and so on. The number of pressure chambers 13 communicating with the supply channels 14 is not limited.

According to the present embodiment, channels are disposed to generate an ink circulation flow through the pressure chambers 13 and the discharge ports 11.

As illustrated in FIG. 3B, each of the first common supply channels 17 extending in the first direction communicates with the plurality of the supply channels 14 and further communicates with the pressure chambers 13 through the respective supply channels 14. Likewise, each of the first common collection channels 18 extending in the first direction communicates with the plurality of the collection channels 15 and further communicates with the pressure chambers 13 through the respective collection channels 15.

As described above, a series of ink flow channels including the supply channels 14, the collection channels 15, the first common supply channels 17, and the first common collection channels 18 is disposed in the first channel layer 22 and the second channel layer 23 so as to correspond to each of the discharge port arrays 16. Through the ink channels, an ink circulation flow can be generated in the pressure chambers 13 of the liquid discharge substrate and in the discharge ports 11 of the orifice plate 21.

### First Embodiment

A configuration of a liquid discharge head 3 according to the first embodiment is described with reference to FIGS. 1A to 1C. When the above described liquid discharge unit 300 is used, the first embodiment is effective for a liquid discharge head 3 for which removal of dust and foreign substances adhering to members from initial state needs to be performed. A configuration of the liquid discharge head 3 having the above described liquid discharge unit 300 is described below.

FIGS. 1A and 1B are diagrams each illustrating an overall configuration of the liquid discharge head 3 according to the present embodiment. FIG. 1C is an exploded perspective view illustrating the liquid discharge head 3. The liquid discharge head 3 includes an electrical wiring substrate 90 for receiving electrical signals and electric power from the main body via signal input terminals 91 and a power supply terminal 92. The electrical wiring substrate 90 is fixed to a liquid discharge unit support member 81 with screws and bonded to a housing. The electrical wiring substrate 90 is bonded to the recording element substrates 10 via flexible wiring substrates 40. A recording unit 200 includes the flexible wiring substrates 40 and the recording element substrates 10, and is supported by a cover member 130. Thus, the recording element substrates 10 receive electrical signals and electric power from the main body to drive the ink discharge. The liquid discharge head 3 has a total of seventeen recording element substrates 10 to enable printing over the entire sheet width. The liquid discharge head 3 does not move. Rather, a recording medium moves under the liquid discharge head 3 to complete printing. Each of the recording element substrates 10 has about 8,192 discharge ports each of which discharges about two picoliters (pL) of ink. The liquid discharge head 3 includes an ink circulating mechanism in which ink passes through the inside of the liquid discharge head 3 and the tank of the main body (not described), and is then supplied again.

The ink circulation flow according to the present embodiment is described with reference to FIGS. 2A to 2D. FIG. 2A illustrates an overall configuration of the ink circulating mechanism. FIGS. 2B and 2C are cross-sectional views each illustrating the liquid discharge head 3.

The ink circulating mechanism according to the present embodiment is described with reference to FIG. 2A. FIG. 2D illustrates a sequence of ink filling of the ink circulating mechanism according to the present embodiment including a capping unit 400, described below.

A replenishing pump 1005 is driven to move ink from a main tank 1006 storing ink to a buffer tank 1003 for storing ink to be circulated in the circulation system. The ink in the buffer tank 1003 is sent to an ink guide tank 220 by a supply pump 1004 via a liquid connecting portion 111. The ink entered the ink guide tank 220 passes through a filter 251 for removing impurities in the ink, and then enters a negative-pressure control unit 230 in which the ink is separated into a high-negative-pressure chamber and a low-negative-pressure chamber. A differential pressure generated in the negative-pressure control unit 230 is used for the ink circulation in the liquid discharge head 3 described below.

In regular printing, the ink exited the low-negative-pressure chamber (negative-pressure control unit H) enters a common supply liquid chamber 306 via a first inlet port 303, and the ink exited the high-negative-pressure chamber (negative-pressure control unit L) enters a common collection liquid chamber 307 via a second inlet port 304. The common supply liquid chamber 306 and the common collection liquid chamber 307 are completely separated from each other by the liquid chamber partition wall 305. At this time, a differential pressure is generated in the ink entered into the two common liquid chambers. The ink in the common supply liquid chamber 306 with a low negative pressure flows into the common collection liquid chamber 307 with a high negative pressure via the channels of the recording element substrates 10. Then, a discharge pump 1002 reduces a pressure in a first discharge channel 308 and a second discharge channel 310, the ink in the common supply liquid chamber 306 is discharged from a first outlet port 320, and the ink in the common collection liquid chamber 307 is discharged from a second outlet port 321. The discharged ink is collected in the buffer tank 1003, to establish ink circulation. The common supply liquid chamber 306, the common collection liquid chamber 307, and the liquid chamber partition wall 305 are configured by the fifth channel layer 26 and the sixth channel layer 27 illustrated in FIG. 3A.

In this circulation, since the negative-pressure control unit 230 and the liquid discharge unit 300 are disposed downstream of the filter 251, if dust and foreign substances are present in these units, the discharge ports of the recording element substrates 10 may be clogged. Thus, when the liquid discharge head 3 is filled with ink for the first time, the ink is prevented from being introduced into the common collection liquid chamber 307 to establish a circulation path without the recording element substrates 10 discharging dust and foreign substances from the first discharge channel 308. Then, the above-described ink circulation in regular printing is performed.

To prevent ink from being introduced into the common collection liquid chamber 307, a collection-side outlet valve 311 provided in the second discharge channel 310 is maintained in a closed state. When the ink is not flowing, the negative-pressure control unit 230 does not perform the negative-pressure adjustment. Therefore, when the collection-side outlet valve 311 is closed, the negative-pressure control unit H does not operate, so that the pressure in the common collection liquid chamber 307 becomes higher than the pressure in the common supply liquid chamber 306.

When the discharge pump 1002 is driven in this state, the ink introduced into the common supply liquid chamber 306 passes through the first discharge channel 308, without passing through the recording element substrates 10, and then is discharged from the liquid discharge head 3. At this time, the pressure in the first discharge channel 308 reduced by the discharge pump 1002 is lower than the pressure in a first introduction channel 302 adjusted by the negative-pressure control unit 230.

Even if a small amount of ink is introduced into the common collection liquid chamber 307 in a state where the collection-side outlet valve 311 is closed, the capping unit 400 prevents the ink from being introduced into the discharge ports. FIG. 2B is a cross-sectional view illustrating the liquid discharge head 3 including the capping unit 400. The capping unit 400 includes a cap 401 for covering the recording element substrates 10, an in-cap liquid discharge channel 405 communicating with the discharge ports, an in-cap outlet valve 402, an in-cap outlet pump 403, and a liquid discharge tank 404. When the in-cap outlet valve 402 is closed, the in-cap liquid discharge channel 405 is closed, preventing ink from flowing into the discharge ports.

Similar to the above-described configuration, a supply side outlet valve 309 is provided to the first discharge channel 308 to prevent ink from being introduced into the common supply liquid chamber 306 so that a circulation path without the recording element substrates 10 is established. With this configuration, dust and foreign substances are discharged from the second discharge channel 310.

### Second Embodiment

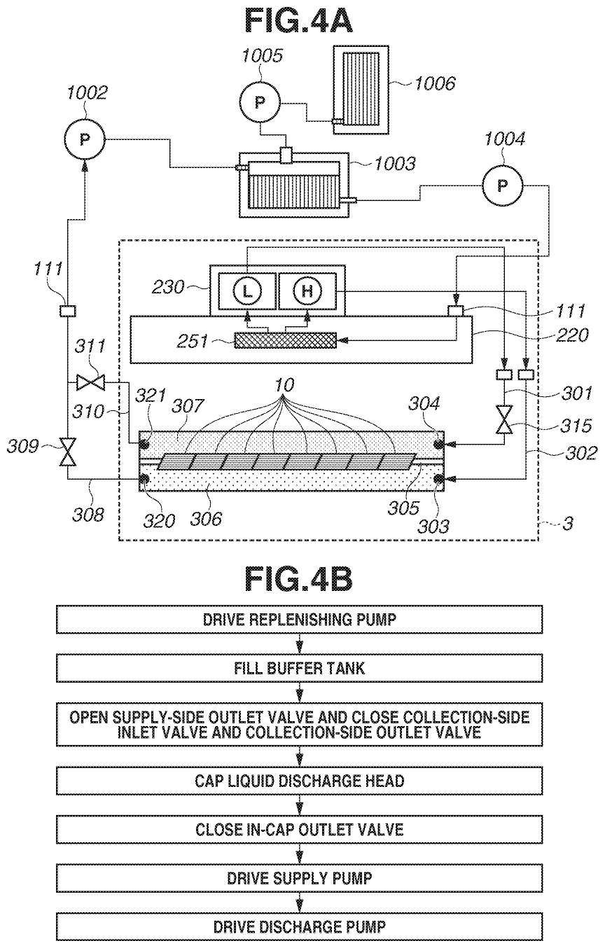

A second embodiment is described with reference to FIGS. 4A and 4B. FIG. 4A is a diagram illustrating a configuration of the second embodiment configured by adding a collection-side inlet valve 315 to a second introduction channel 301 in the configuration of the first embodiment. FIG. 4B is a diagram illustrating a sequence of ink filling.

A supply pump 1004 pressurizes the downstream path to send ink to the ink guide tank 220. In a state where a collection-side outlet valve 311 is closed, the pressurization may cause the ink to be supplied from the negative-pressure control unit 230 to both a common collection liquid chamber 307 and a common supply liquid chamber 306. Therefore, by closing the collection-side inlet valve 315, introduction of ink into the common collection liquid chamber 307 can be completely prevented. In this way, the ink can be introduced only into the common supply liquid chamber 306. In this configuration, since the valve needs to be disposed inside the liquid discharge head 3, a separate power source may be required.

### Third Embodiment

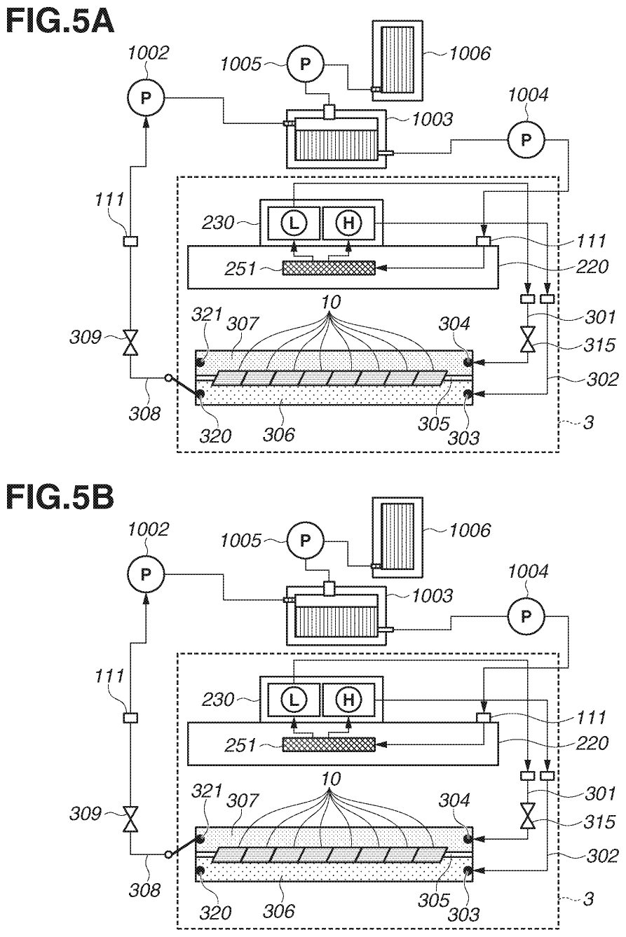

A third embodiment is described with reference to FIGS. 5A and 5B. The third embodiment eliminates the second discharge channel 310 and the collection-side outlet valve 311 from the second embodiment. A first discharge channel 308 is connectable with one of a first outlet port 320 and a second outlet port 321.

In FIG. 5A, the first discharge channel 308 is connected to the first outlet port 320. When a liquid discharge head 3 is filled with ink for the first time, a collection-side inlet valve 315 is closed. The pump system is driven in this state, so that ink is discharged from the first outlet port 320 without passing through recording element substrates 10.

After completion of the process, filling operation is performed by connecting the first discharge channel 308 with the second outlet port 321 as illustrated in FIG. 5B to be ready for printing.

### Fourth Embodiment

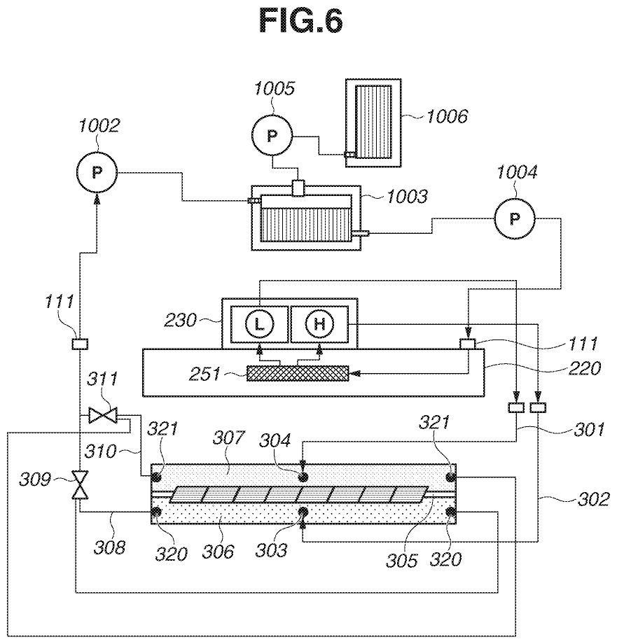

A fourth embodiment is described with reference to FIG. 6. According to the fourth embodiment, a first inlet port 303 is disposed in a proximity of the center of a liquid discharge head 3, and ink flows from the first inlet port 303 to outlet ports 320 at both ends. Like the first embodiment, when the liquid discharge head 3 is filled with ink for the first time or after replacement of the liquid discharge head 3, a collection-side outlet valve 311 is closed to prevent ink from entering a common collection liquid chamber 307.

The present disclosure provides a highly reliable liquid filling method and a liquid discharge head with, for example, improved discharge stability.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-049638, filed Mar. 25, 2025, which is hereby incorporated by reference herein in its entirety.

What is claimed is:

1. A method for filling a liquid discharge head including:
a recording element substrate configured to discharge a liquid;
a common supply liquid chamber configured to supply the liquid to the recording element substrate;
a first introduction channel configured to introduce the liquid into the common supply liquid chamber;
a first discharge channel configured to discharge the liquid from the common supply liquid chamber;
a common collection liquid chamber configured to collect the liquid from the recording element substrate;
a second introduction channel configured to introduce the liquid into the common collection liquid chamber; and
a second discharge channel configured to discharge the liquid from the common collection liquid chamber,
the method comprising introducing the liquid from the first introduction channel into the common supply liquid chamber in a state where the second discharge channel is closed and the first discharge channel is open.

2. The method according to claim 1,
wherein the second discharge channel is provided with a collection-side outlet valve, and
wherein, in the introducing, the collection-side outlet valve is closed.

3. The method according to claim 1, wherein the liquid introduced into the common supply liquid chamber is discharged from the common supply liquid chamber by reducing pressure in the first discharge channel.

4. The method according to claim 3, further comprising:
a discharge pump configured to reduce the pressure in the first discharge channel.

5. The method according to claim 4, wherein the pressure in the first discharge channel reduced by the discharge pump is less than pressure in the first introduction channel.

6. The method according to claim 4, wherein the liquid discharge head is provided in a liquid discharge apparatus that includes the liquid discharge head.

7. The method according to claim 1, wherein, in a liquid discharge apparatus including the liquid discharge head and a capping unit configured to cap the liquid discharge head, the introducing is performed in a state where the capping unit covers the recording element substrate.

8. The method according to claim 7,
wherein the capping unit includes:
an in-cap liquid discharge channel communicating with a discharge port included in the recording element substrate, and
an in-cap outlet valve disposed in the in-cap liquid discharge channel, and
wherein, in the introducing, the in-cap outlet valve is closed in a state where the capping unit covers the recording element substrate.

9. The method according to claim 1,
wherein the second introduction channel is provided with a collection-side inlet valve, and
wherein, in the introducing, the collection-side inlet valve is closed.

10. A method for filling a liquid discharge head including:
a recording element substrate configured to discharge a liquid;
a common supply liquid chamber configured to supply the liquid to the recording element substrate;
a first introduction channel configured to introduce the liquid into the common supply liquid chamber;
a first discharge port configured to discharge the liquid from the common supply liquid chamber;
a common collection liquid chamber configured to collect the liquid from the recording element substrate;
a second introduction channel configured to introduce the liquid into the common collection liquid chamber;
a second discharge port configured to discharge the liquid from the common collection liquid chamber; and
a discharge channel configured to connect with one of the first discharge port and the second discharge port,
the method comprising introducing the liquid from the first introduction channel into the common supply liquid chamber in a state where the discharge channel connects with the first discharge port.

11. A liquid discharge head comprising:
a recording element substrate configured to discharge a liquid;
a common supply liquid chamber configured to supply the liquid to the recording element substrate;
a first introduction channel configured to introduce the liquid into the common supply liquid chamber;
a first discharge port configured to discharge the liquid from the common supply liquid chamber;
a common collection liquid chamber configured to collect the liquid from the recording element substrate;
a second introduction channel configured to introduce the liquid into the common collection liquid chamber;
a second discharge port configured to discharge the liquid from the common collection liquid chamber; and
a discharge channel configured to connect with one of the first discharge port and the second discharge port.
